(19) United States
(12) Patent Application Publication
(10) Pub. No.: US 2014/0375882 A1
(43) Pub. Date: Dec. 25, 2014

(54) PROCESSING VIDEO STREAMS

(71) Applicant: Dmitrii Igorevich GAIAZOV, Yoshkar-Ola (RU)

(72) Inventor: Dmitrii Igorevich GAIAZOV, Yoshkar-Ola (RU)

(73) Assignee: Limited Liability Company "E-Studio", Yoshkar-Ola (RU)

(21) Appl. No.: 14/458,401

(22) Filed: Aug. 13, 2014

Related U.S. Application Data
(63) Continuation-in-part of application No. PCT/RU2014/000290, filed on Apr. 21, 2014.

(30) Foreign Application Priority Data
Apr. 24, 2013 (RU) 2013118988

(51) Int. Cl. H04N 11/20; H04N 11/24

(52) U.S. Cl. CPC H04N 11/20; H04N 11/004
USPC 348/453

(57) ABSTRACT

A method of creating a video stream is provided. The method includes receiving into non-transitory memory first and second video streams. The first video stream is different from the second video stream. Each video stream includes a series of video images each having a plurality of pixels. Each pixel has a luminance component and two chrominance components. The method includes converting, using a computing processor, the luminance component of a first pixel in a first image of the first video stream into an opacity component. The method also includes combining, using the computing processor, the opacity component of the first pixel and color components of a second pixel into an output pixel. Finally, the method includes outputting an output video stream comprising the output pixel.

### CROSS-REFERENCE TO RELATED APPLICATIONS

This application is a continuation-in-part of International Application PCT/RU2014/000290 filed on Apr. 21, 2014, which claims priority benefits to Russian Patent Application 2013118988 filed on Apr. 24, 2013, the entire disclosures of which are incorporated herein by reference.

### TECHNICAL FIELD

This disclosure relates to processing two video streams failing to support an alpha channel to output a video stream that supports an alpha-channel.

### BACKGROUND

Video games involve interface between a person (e.g., user) and a device that generates visual feedback (e.g. output video) on a visual display (e.g., video device such as a monitor or a television). Most video games include a controller allowing the user to manipulate and control objects within a game. A controller may include one or more of the following: a joystick; buttons; and/or a mouse. When the user pushes the buttons or manipulates the joystick, the behavior of certain objects within the video game reacts to the user's action. Therefore, the user manipulates these objects based on different factors including but not limited to, rules of the game, strategy that the user is following to reach a game objective (i.e., win the game). Moreover, video games provide the user with both a visual and an audio experience. The actions of the user may also provide an audio feedback relating to the object being manipulated by the user.

A user may play video games on a computer, a television, or using a separate console system specifically designed for the game in combination with one of a monitor or a television. Video games support one user or multiple users. In some cases, the users are connected to a network allowing the users to play a game provided by a server, or allowing the users to play together (e.g., multi-player games), or both.

Alpha channels can be used for increasing visual impressions from video games. Advantageously, alpha channels provide visual appeal to video images. Furthermore, alpha channels provide high-speed processing of video streams for further playback.

### SUMMARY

It is an object of the present invention to simplify processing video streams for creating an output video stream as well as to decrease load experienced by computer units, such as computer engines.

One aspect of the disclosure provides a method of creating a video stream. The method includes receiving into non-transitory memory first and second video streams, the first video stream being different from the second video stream. Each of the video streams includes a series of video images each having a plurality of pixels. Each pixel has a luminance component and two chrominance components. The method further includes converting, using a computing processor, the luminance component of a first pixel in a first image of the first video stream into an opacity component, and combining, using the computing processor, the opacity component of the first pixel and color components of a second pixel into an output pixel. The method finally includes outputting an output video stream comprising the output pixel.

Thus, the present method of creating a video stream enables an accelerated processing of the video stream which does not maintain the alpha channel during creating a video stream which maintains the alpha channel.

Implementations of the disclosure may include one or more of the following features. In some implementations, if a value of the opacity component is about zero, the method includes converting the chrominance and luminance components of a second pixel in a second image of the second video stream to an RGB color space having color components including a red-component, a green-component, and a blue-component. In some examples, if the value of the opacity component is not equal to zero or about zero, the method includes inserting a value of 1 in each of the RGB color space components and a value of 0 in the opacity component.

In some implementations, converting the luminance component of a first pixel in a first image of the first video stream to an opacity component includes performing the following calculation: A=Y/C; where A is a value of the opacity component and Y is a received Y component of a pixel from the first video stream, and C is a constant integer. The value of C may be 255. Additionally, calculating the RGB color space components may include using the following equations:

R=Y+1.13983*V;

G=Y−0.39465*U−0.58060*V; and

B=Y+2.03211*U;

where Y, U, and V are the luminance and chrominance values respectively of a pixel in the second video stream, and R, G, B, are a red component, a green component, and a blue component values respectively of a pixel in the output video stream.

Another aspect of the disclosure provides a method of creating two video streams lacking support for an alpha channel from a video stream supporting an alpha channel component. The method includes receiving into non-transitory memory a video stream having color components and an opacity component in a first color space, and converting, using a computing processor, the color components from the first color space into color components of a second color space. The method also includes converting, using the computing processor, the opacity component into a color component of the second color space. The method further includes outputting a first video stream having the converted color components, and outputting a second video stream having the converted opacity component. In some examples, first color space is RGBA and the second color space is YUV.

In some implementations, converting the opacity component includes calculating Y=A*C; where A is a value of the opacity component, Y is a luminance component of the second outputted video stream, and C is a constant integer. The constant C may equal 255. In some examples, converting the color components from the first color space to color components of a second color space include performing the following calculation:

Y=0.299*R+0.587*G+0.114*B;

U=−0.14713*R−0.28886*G+0.436*B;

V=0.615*R−0.51499*G−0.10001*B;

where Y is a Y component for the second video stream, U is a U component of the second video stream, and V is a V component of the second video stream, and R, G, B, are a red component, a green component, and a blue component values respectively of an output pixel.

Another aspect of the disclosure provides a system for creating a video stream. The system includes a receiver receiving and storing first and second video streams into non-transitory memory, each video stream has a luminance component and two chrominance components. The first video stream is different than the second video stream. The device includes a first converter and a second converter, both executing on a computing processor. The first converter converts the luminance component of the second video stream into an opacity component. The second converter converts the chrominance and luminance of the first video stream into an output video stream having an RGB color space when a value of the opacity component is about zero. The system includes a combiner executing on the computing processor and combining the output video stream and the opacity component and outputting the combined video stream.

In some implementations, the first converter converts the luminance component of the second video stream into an opacity component using the following equation: A=Y/C; where A is a value of the opacity component and Y is a received Y component from the first video stream, and C is a constant integer. C may equal 255.

In some examples, the second converter converts the chrominance and luminance of the first video stream into an output video stream having an RGB color space using the following equations:

R=Y+1.13983*V;

G=Y−0.39465*U−0.58060*V; and

B=Y+2.03211*U;

where Y, U, and V are luminance and chrominance values respectively of a pixel in the second video stream, and R, G, B, are a red component, a green component, and a blue component values respectively of an output pixel.

In yet another aspect of the disclosure, a system for creating first and second video streams is provided. The system includes a receiver receiving and storing an input video stream into non-transitory memory. The video stream is in an RGBA color space comprising a red component, a green component, a blue component, and an alpha component. The system includes a splitter executing on a computing processor. The splitter converts the alpha component into a first output video stream, and converts the red component, the green component, and the blue component into a second output video stream in a YUV color space. The splitter also outputs the first and second output video streams.

In some examples, the system converts the alpha component using the following equations: Y=A*C; where A is an alpha channel value, Y is a luminance component of the second outputted video stream, and C is a constant integer. C may equal to 255.

In some examples, converting the red component, the green component, and the blue component into a second output video stream in a YUV color space comprises performing the following calculations:

Y=0.299*R+0.587*G+0.114*B;

U=−0.14713*R−0.28886*G+0.436*B;

V=0.615*R−0.51499*G−0.10001*B;

where Y is the Y component for the second video stream, U is the U component of the second video stream, and V is the V component of the second video stream, and R, G, B, are a red component, a green component, and a blue component values respectively of an output pixel.

In yet another aspect of the disclosure, a method of processing a video stream is provided. The method includes creating two video streams lacking support for an alpha channel from a video stream supporting an alpha channel component, by receiving into non-transitory memory a video stream having color components and an opacity component in a first color space, and converting, using a computing processor, the color components from the first color space into color components of a second color space. The method also includes converting, using the computing processor, the opacity component into a color component of the second color space. The method further includes outputting a first video stream having the converted color components, and outputting a second video stream having the converted opacity component. In some examples, first color space is RGBA and the second color space is YUV. The method includes receiving into non-transitory memory the first and second video streams, the first video stream being different from the second video stream. Each video stream includes a series of video images each having a plurality of pixels. Each pixel has a luminance component and two chrominance components. The method further includes converting, using a computing processor, the luminance component of a first pixel in a first image of the first video stream into an opacity component, and combining, using the computing processor, the opacity component of the first pixel and color components of a second pixel into an output pixel. The method finally includes outputting an output video stream comprising the output pixel.

In some implementations, converting the opacity component includes calculating Y=A*C; where A is a value of the opacity component, Y is a luminance component of the second outputted video stream, and C is a constant integer. The constant C may equal 255. In some examples, converting the color components from the first color space to color components of a second color space include performing the following calculation:

Y=0.299*R+0.587*G+0.114*B;

U=−0.14713*R−0.28886*G+0.436*B;

V=0.615*R−0.51499*G−0.10001*B;

where Y is a Y component for the second video stream, U is a U component of the second video stream, and V is a V component of the second video stream, and R, G, B, are a red component, a green component, and a blue component values respectively of an output.

Implementations of the disclosure may include one or more of the following features. In some implementations, if a value of the opacity component is about zero, the method includes converting the chrominance and luminance components of a second pixel in a second image of the second video stream to an RGB color space having color components comprising a red-component, a green-component, and a blue-component. In some examples, if the value of the opacity component is not equal to zero or about zero, the method includes inserting a value of 1 in each of the RGB color space components and a value of 0 in the opacity component.

In some implementations, converting the luminance component of a first pixel in a first image of the first video stream to an opacity component includes performing the following calculation: A=Y/C; where A is a value of the opacity component and Y is a received Y component of a pixel from the first video stream, and C is a constant integer. The value of C may be 255. Additionally, calculating the RGB color space components may include using the following equations:

R=Y+1.13983*V;

G=Y−0.39465*U−0.58060*V; and

B=Y+2.03211*U;

where Y, U, and V are the luminance and chrominance values respectively of a pixel in the second video stream, and R, G, B, are a red component, a green component, and a blue component values respectively of a pixel in the output video stream.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary gaming system over a network.

FIG. 2 is a schematic view of an exemplary client system of FIG. 1A.

FIG. 3 is a schematic view of two exemplary video sources being combined.

FIG. 4A is a schematic view of an exemplary processor for combining two video sources.

FIG. 4B is a schematic view of an exemplary processor for separating a video source.

FIG. 5 is a schematic view of two YUV video streams being converted to an RGBA video output.

FIG. 6 is a flow chart of combining two video streams resulting in one output video stream having an alpha channel.

FIG. 7 provides an exemplary arrangement of operations for a method of processing two video inputs and outputting a video output having an alpha channel.

FIG. 8 provides an exemplary arrangement of operations for a method of processing a video input having an alpha channel and outputting two video channels that do not support alpha channel.

Like reference symbols in the various drawings indicate like elements.

### DETAILED DESCRIPTION

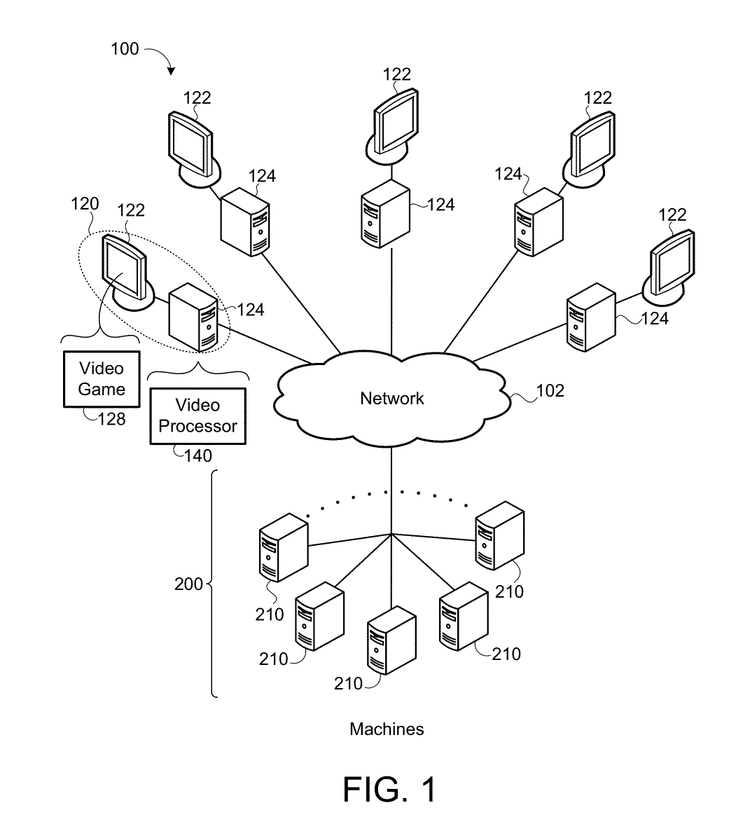

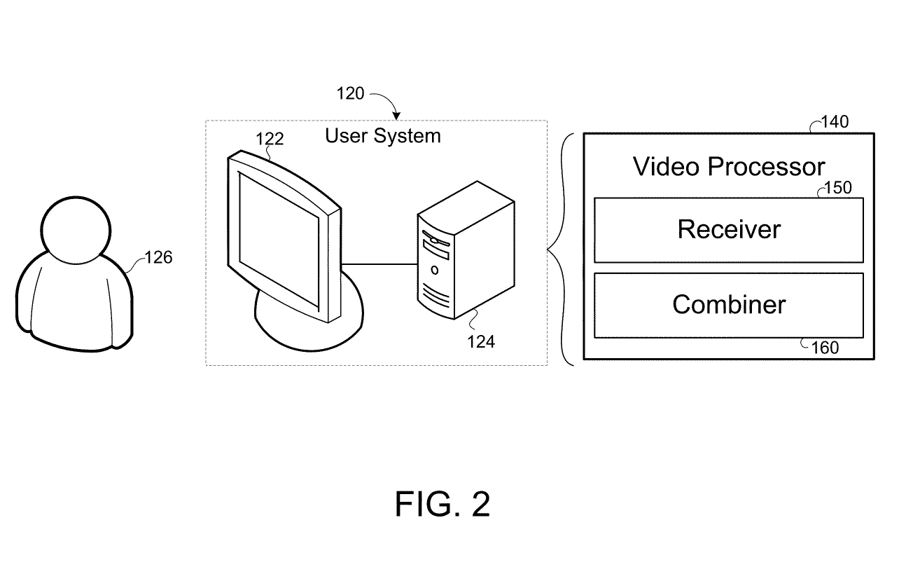

Referring to FIG. 1A and 1B, in some implementations, a video gaming system 100 includes a group of loosely coupled machines 210 (e.g., memory hosts, computing processor, computer, etc.) implementing a distributed system through a network 102. Each machine 210 has a computing resource (e.g., non-transitory memory, flash memory, dynamic random access memory (DRAM), phase change memory (PCM), and/or disks. The network 102 allows users 126 to access a service 128 (e.g., video gaming, video viewing) provided by a machine 210 (also referred to as a server).

In some implementations, a user or a player 126 has a user system 120 that may include a personal computer or a video game console to play the video game 128. Each user system 120 includes a display 122(e.g., monitor, television) to view the objects of the game 128, and a video processor 140 for processing the video to be displayed on the display 122. In some examples, the user system 120 is one device having the display and a system unit 124. The system unit 124 includes a central processing unit (CPU) or a microprocessor, random access memory. They system unit 124 may include a video processor 140. The video processor 140 may in turn include a receiver 150 for receiving video streams and a combiner 160 for combining the video stream and the audio stream, or multiple video streams before being displayed on the display 122. The network 102 may be a local network or the internet. In some examples, each player 126 accesses a video game 128 separate from other players 126 (e.g., single player games). In other examples, different players 126 may access the same game 128, which may be at the same time (e.g., multi-player games).

In some implementations, a user 126 plays a browser game 128 over the network 102 (e.g., via the Internet) that uses a web browser as a client. Browser games 128 may be created and run using standard web technologies or browser plug-ins. A browser plug-in is a set of software components that add specific abilities to a larger software application (e.g., Internet Explorer, Firefox). For example, a plug-in may allow a user 126 to play a video, scan for viruses, or play a video game 128 using a web browser which is not capable of supporting such activities without a plug-in. A plug-in is usually developed by third-party developers separate from the user 126 or the server 210 providing a specific service to the client 120 that is not otherwise available without the plug-in. Therefore, the plug-in provides the user 126 with new features and new capabilities that were not possible using the application provided.

A container or wrapper format is a file format that can store multiple data forms. The container format describes the coexistence and interaction of different data elements stored in a computer file for later processing. Some examples of container files include files having different types of audio and video resulting in the display of a video. Some container files include, but are not limited to, 3GP which is used by mobile phones, ASF is used by Microsoft WMA and WMV, DVR-MS—“Microsoft Digital Video Recording”, proprietary video container format developed by Microsoft Corporation, QuickTime File Format used by QuickTime video container from Apple Inc., Flash Video is a container for video and audio from Adobe Systems, MPEG program stream is a container for MPEG-1 and MPEG-2, MP4 is that standard audio and video container for the MPEG-4 multimedia portfolio, based on the ISO base media file format defined in MPEG-4 Part 12 and JPEG 2000 Part 12, which in turn was based on the QuickTime file format, and Ogg is the standard container for Xiph.org audio format Vorbis and video format Theora.

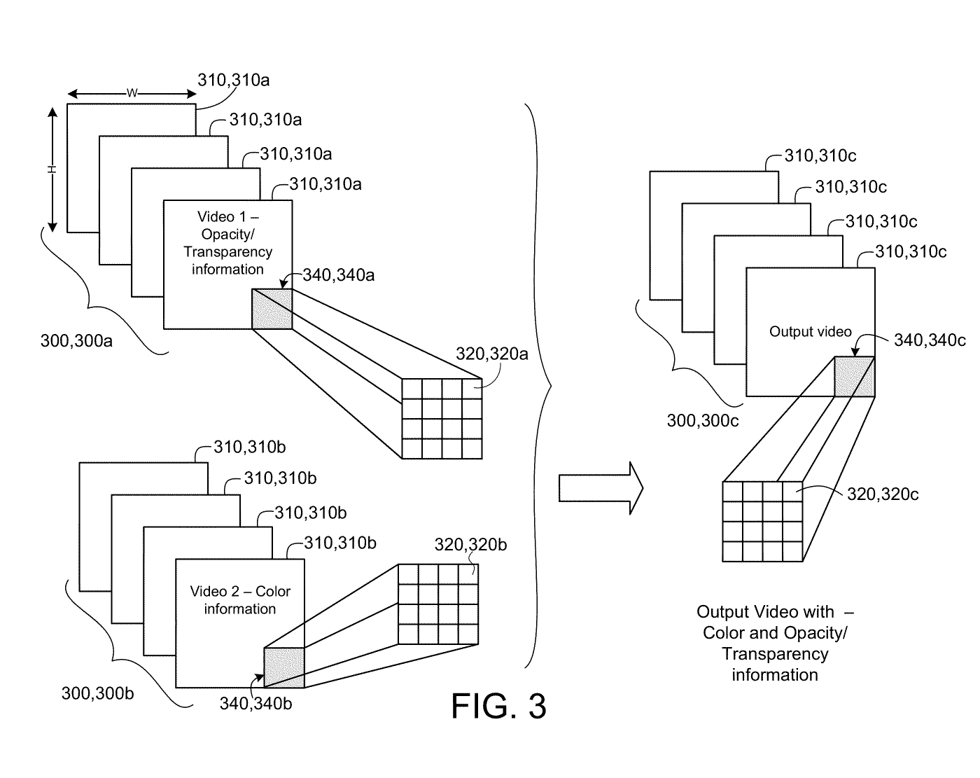

Referring to FIG. 3, a video stream 300 is composed of a multitude of film frames 310 or video frames 310, each representing a still image. The combination of the film frames 310 or video frames 310 create a complete moving picture. When a video stream 300 is displayed on a display 122, each video frame 310 is displayed for a short period of time (e.g., 1/24 seconds i.e., 24 frames per second), and then replaced by a following video frame 310. The video frames 310 are displayed sequentially to create a scene of the complete moving picture. Digital video frames 310 include a number of pixels 320, each pixel representing a color. The color is represented by a fixed number of bits. The more bits the more colors can be supported and later displayed. The pixels define the frame 310 height H and width W. In some examples, the frame may have a width W of 640 pixels and a height H of 480 pixels. Other combinations of height H and width includes, but is not limited to: 800×600, 1024×600, 1280×720.

In some implementations, video streaming over a network 102 requires compressing the video stream 300 to reduce the redundancy in the video data. Most video compression techniques use spatial image compression and temporal motion compensation. Spatial image compression includes reducing the number of pixels in an image or frame by detecting regions within a frame with similar pixel data and compressing the video data corresponding to those regions. Temporal motion compensation shrinks the amount of video data by detecting similarities between corresponding pixels in subsequent video frames and encoding the redundancy information, taking up less space when the video is stored or transmitted.

Video compression is mostly lossy compression, which means some of the data quality of the original video is lost. Video compression considers a frame 310 in a motion video and operates on a square-shaped group of neighboring pixels (i.e., macroblocks). The macroblocks 340 are then evaluated and compared from one frame 310 to the next and the compression codec only sends the difference between the two blocks. A video codec is a hardware or software implementation of specific video compression and/or decompression file format. Since most videos include a series of images and audio associated with the image, separate compression and decompression for the audio and the video is performed. The separate compressed files, audio and video, are bundled in a container format.

A color space may be used to specify, create, and visualize color. In some examples, humans define color by its attributes such as brightness, hue, and colorfulness. Brightness is what we as humans perceive an object to exhibit more or less light. Hue describes an area's similarity to the perceived primary colors, red, green, and blue. Colorfulness is what an area appears to exhibit more or less hue. A computer may define a color by the amounts of primary colors emitted to match a color. Therefore, a color may be defined in a multitude of ways, depending on the reference point. Thus a color space is needed to define the reference point when defining a color. There are several color spaces due to the different applications of each color space. For example, some applications have limited equipment and can only handle a specific amount of colors.

A color model describes the way colors can be represented as a group of numbers, usually by three or four numbers or color components. Some of the color models include RGB, CMYK, YIQ, and YUV.

RGB (Red Green Blue) color model adds the primary colors of red, green, and blue in different portions to reproduce a broad array of colors. RGB is an additive color model because it indicates how much of each primary color is added to create a final color. For example, equal portions of red and green produce yellow, equal portion of red and blue produce magenta, and equal portions of blue and green produce cyan. The full range of color available in the RGB color model is defined by all the possible combinations of all the possible portions of each primary color. When representing an RGB color for digital imaging, each pixel 320 of the image is defined by three values, red, green, and blue. For an 8-bit per-channel, each color can range from values 0 to 255. Therefore, to achieve the color red the pixel is represented by (255, 0, 0). To achieve the color blue, the pixel is represented by (0,0,255). Finally, to achieve the color green, the pixel is defined by (0,255,0).

YUV is a color model defined in terms of luminance (Y) and two chrominance (UV) components. The luminance component represents the brightness of an image (i.e., the black and white or achromatic portion of the image). The chrominance component coveys the color information of a picture.

In some implementations, alpha composition is used to combine an image with a background to create the appearance of partial or full transparency. In some examples, image elements are rendered in separate passes and later combined to create a resulting image. The combination of the separate image elements is performed by a process called composite. Composition is widely used when combining two image elements specifically when combining live footage and computer generated images. Alpha blending combines a translucent foreground with a background color and produces a new blended image. The transparency of the blended image depends on the value of alpha, therefore, if the foreground color is completely transparent, then the blended color is the background. However, if the blended image is completely opaque, the blended color will be the foreground color. The value of alpha may range from 0 (or 0%) to 1 (or 100%), where a value of 0 indicates that the blended image will be fully transparent (i.e., invisible), and a value of 1 indicates a fully opaque color (i.e., image will show). The alpha channel may be of any value between 0 and 1, making the image show through a background such as glass (translucency).

RGBA (red green blue alpha) is a simple use of the RGB color model described above, including extra information relating to the alpha channel. The additional alpha component 328c in RGBA allows for alpha compositing. The alpha channel 328c specifies how a pixel's colors should be merged with another pixel when the two pixels are overlaid.

Referring to the table below for examples of the opacity of the color red (255, 0, 0) in the RGBA color space:

TABLE 1

| Alpha | RGBA | Opacity/Transparency |
|---|---|---|
| 0.0 | 255, 0, 0, | 0% opaque or Fully Transparent |
| | 0.0 | |
| 0.2 | 255, 0, 0, | 20% opaque or 80% Transparent |
| | 0.2 | |
| 0.4 | 255, 0, 0, | 40% opaque or 60% Transparent |
| | 0.4 | |
| 0.6 | 255, 0, 0, | 60% opaque or 40% Transparent |
| | 0.6 | |
| 0.8 | 255, 0, 0, | 20% opaque or 80% Transparent |
| | 0.8 | |
| 1.0 | 255, 0, 0, | Fully opaque or 0% Transparent |
| | 1.0 | |

Referring to FIG. 3, 4A, 5, and 6, in some implementations, the system 120 receives two video steams 300a, 300b incapable of storing an alpha component 328c. The first video stream 300a stores information regarding the transparency of each pixel 320a within a frame 310a, and the second video stream 300b includes information regarding the color of the pixels 320b in each frame 310b. The system 120 processes the two incoming video streams 300a, 300b and combines the two to output an output video stream 300c having an alpha component 328c denoting the transparency of the combined image 310c. The processor 140 receives the first video stream 300a and calculates the alpha channel component of each pixel 320a within a frame 310a. If the pixel 320 calculated is fully transparent or almost fully transparent, then the system does not further process the pixel from the second video stream. In some examples, the system uses a default value for the color. The system may have a default value to use for the output video stream.

In some implementations, the first and second video streams 300a, 300b are in the YUV color space, and the system 120 combines the two video streams 300a, 300b resulting in an RGBA output stream 300c. The system 120 receives the first YUV video stream 300a including a Y component 322a, a U component 323a, and V component 324a. The Y component 3220 is used as a placeholder for the alpha component 328c. The system then converts the stored Y value 322a to an alpha value 328c using equation 1:

A=Y/C (1)

where A is the value of the alpha component 328c and Y is the received Y component 322a from the first YUV video stream 300a. The Y component 322a is divided by a constant C. In some examples, C equals 255 since the Y component is a one byte having an integral value of 255. If the alpha component 328c is equal to zero or close to zero (about 1%), then the pixel 320c it defines is fully transparent or 0% opaque and the corresponding pixels from the second video stream 300b is not decoded, and the output stream 300c will contain a default value. However, if the alpha component 328c is not equal to zero or close to zero (about 1%), then the YUV value from the second video stream 300b is calculated based on the conversion equations below.

R=Y+1.13983*V (2)

G=Y−0.39465*U−0.58060*V (3)

B=Y+2.03211*U (4)

where R is the red component 325c of a pixel 320c in a frame 310c of the output video stream 300c, G is the green component 326c in a frame 310c of the output video stream 300c, and B is the blue component 327c in a frame 310c of the output video stream 300c. Therefore, converting the Y component 322a from the first video stream 320a, followed by the conversion of the YUV components 322b, 323b, 324b from the second stream 300b results in an output 300c in the RGBA color space and allows the storage of transparency information without adjusting the codec to support an alpha component 328c.

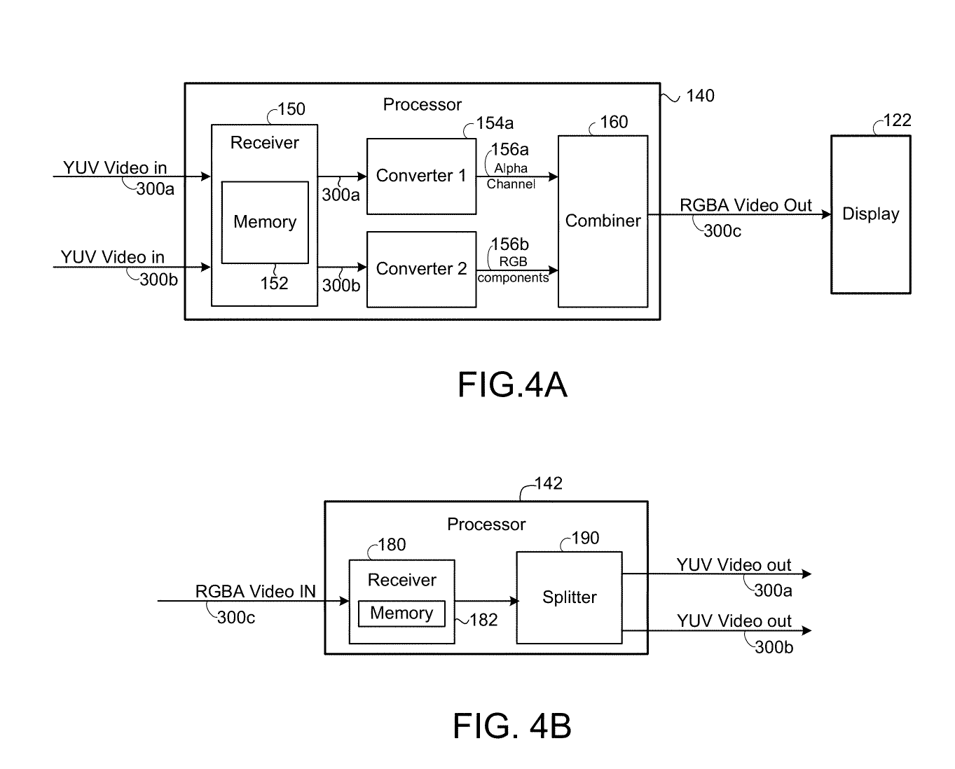

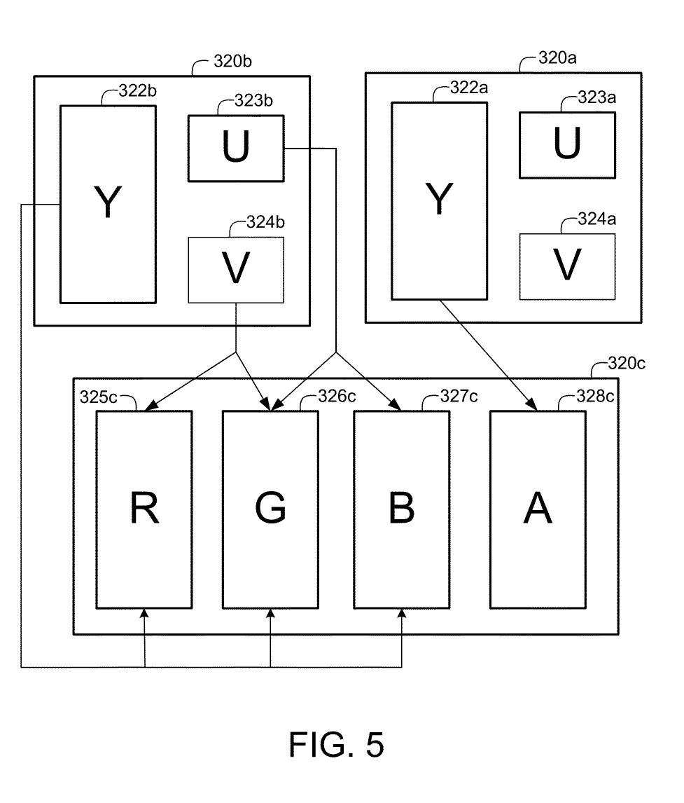

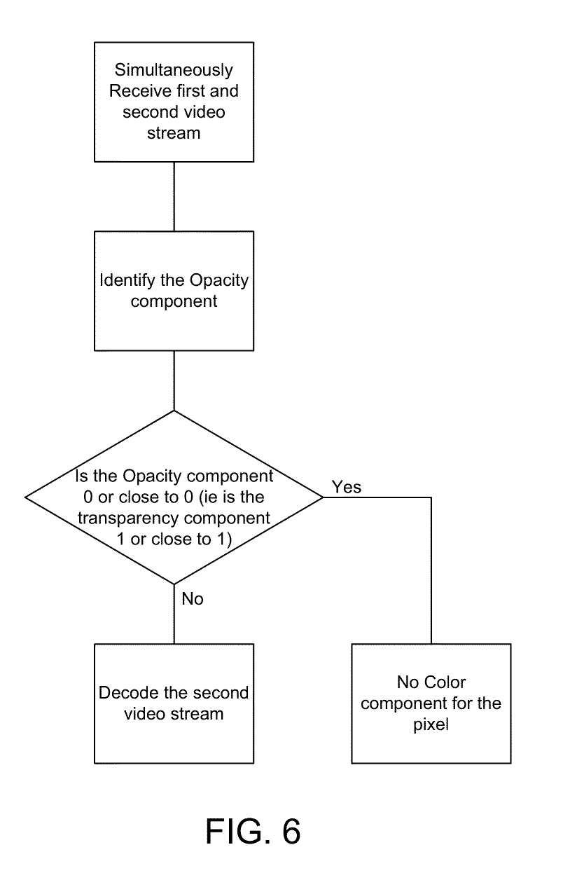

Referring to FIG. 4A, in some implementations, the receiver 150 receives a first video input 300a and a second video input 300b. The first and second video inputs 300a, 300b do not support and alpha component 328c for transparency information relating to an image. The first video input 300a is used to determine an alpha component 328c. If the alpha component 328c is zero or close to zero (about 1%) then the second converter 154b replaces its output with a defined. If the alpha component 328c is not zero or close to zero (around 1%), then the second converter 154b converts the YUV input video 300b to an RGB output video 156b. A combiner 160 combines the alpha channel component and the RGB component to output a video output 300c having an alpha component 328c.

Referring to FIG. 4B, in some implementations, a video stream 300c in the RGBA color space is used to create two separate YUV video streams 300a, 300b. The following equations are used for the conversion:

For video 1:

Y₁=A*C (5)

For video 2:

Y2=0.299*R+0.587*G+0.114*B (6)

U2=−0.14713*R−0.28886*G+0.436*B (7)

V2=0.615*R−0.51499*G−0.10001*B (8)

where Y1 is the Y component 322a for the first video stream 300a, Y2 is the Y component 322b for the second video stream 300b, U2 is the U component 323b for the second video stream 300b, and V2 is the V component 324b for the second video stream 300b. The chrominance components (UV) 323a, 324a of the first video stream 300a are not used.

In some examples, when the video stream 300 contains scenes with a small moving object against a transparent background, each frame 310 contains a large number of pixels 320 whose alpha component 328c is zero or around zero (about 1%). The processor 140 does not perform decoding of the color components of the pixels 322 with the zero alpha component 328c, therefore, increasing the efficiency of the processor significantly.

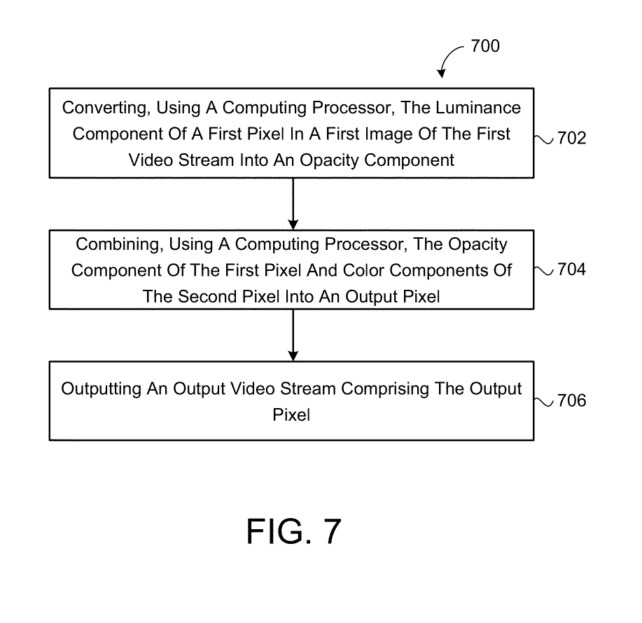

Referring to FIG. 7, in some implementations, a method 700 of creating a video stream 300c is provided. The method 700 includes receiving into non-transitory memory 152 first and second video streams 300a, 300b. The first video stream 300a is different from the second video stream 300b. The first video stream 300 includes opacity information and the second video stream 300b includes color information regarding a pixel with a video frame 310. Each video stream 300 includes a series of video images 310 each having a plurality of pixels 322. Each pixel 320 has a luminance component 322a and two chrominance components 323a, 324a. The method 700 includes converting 702, using a computing processor, the luminance component of a first pixel 322a in a first image 310a of the first video stream 300a into an opacity component 328c, and combining 704, using the computing processor, the opacity component 328c of the first pixel 322a and color components 322b, 323b, 324b of a second pixel 320b into an output pixel 320c. The method 700 finally includes outputting 706 an output video stream 300c including the output pixel 320c.

In some implementations, if a value of the opacity component 328c is about zero (e.g., 0% or about 1%), the method 700 includes converting the chrominance 322b and luminance components 323b, 324b of a second pixel 320b in a second image 310b of the second video stream 300b to an RGB color space having color components comprising a red-component 325c, a green-component 326c, and a blue-component 327c. In some examples, if the value of the opacity component 328c is not equal to zero or about zero, inserting a value of 1 in each of the RGB color space components 325c, 326c, 327c and a value of 0 in the opacity component 328c.

In some implementations, converting 702 the luminance component 322a of a first pixel 320a in a first image 310a of the first video stream 300a to an opacity component 328c includes performing equation 1, as disclosed above. The value of C may be 255. Additionally, calculating the RGB color space components 325c, 326c, 327c may include using equations 2, 3, and 4, as disclosed above.

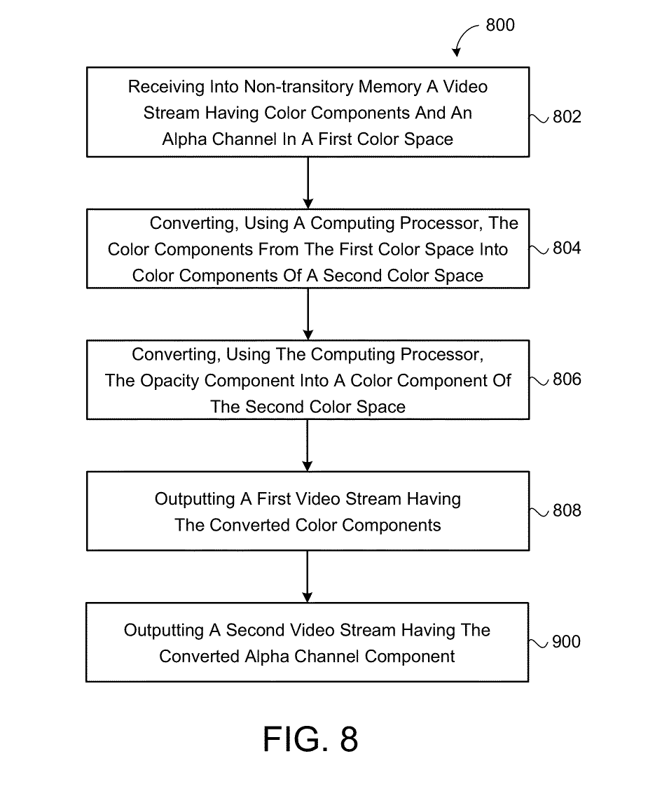

Referring to FIG. 8, in some examples, a method 800 of creating two video streams 300a, 300b lacking support for an alpha component 328c from a video stream 300c supporting an alpha component 328c is provided. The method 800 includes receiving 802 into non-transitory memory 182 a video stream 300c having color components 325c, 326c, 327c and an opacity component 328c in a first color space. The method also includes converting 804, using a computing processor 142, the color components 325c, 326c, 327c from the first color space into color components 322b, 323b. 324b of a second color space. The method 800 includes converting 806, using the computing processor, 142 the opacity component 328c into a color component of the second color space 322a. The method 800 further includes outputting 808 a first video stream 300b having the converted color components 322b, 323b, 324b, and outputting 900 a second video stream 300a having the converted opacity component 322a. In some examples, the first color space is RGBA and the second color space is YUV.

In some implementations, converting the opacity component includes calculating equation 5 as disclosed above. The constant C may equal 255. In some examples, converting the color components from the first color space to color components of a second color space include performing the calculations using equations 6, 7, and 8 disclosed above.

In some examples, a method of splitting a video stream 300c supporting an opacity component 328c (e.g., alpha channel), into two video streams 300a, 300b lacking support for the opacity component 328c, followed by recombining the two video streams 300a, 300b to result in the initial video stream 300c having an opacity component 328c is provided. The method includes a combination of the methods as described with respect to FIGS. 7 and 8.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

1. A method of creating a video stream, the method comprising:
receiving into non-transitory memory first and second video streams, the first video stream being different from the second video stream, each video stream comprising a series of video images each having a plurality of pixels, each pixel having a luminance component and two chrominance components;
converting, using a computing processor, the luminance component of a first pixel in a first image of the first video stream into an opacity component;
combining, using the computing processor, the opacity component of the first pixel and color components of a second pixel into an output pixel; and
outputting an output video stream comprising the output pixel.

2. The method of claim 1, wherein if a value of the opacity component is about zero, converting the chrominance and luminance components of a second pixel in a second image of the second video stream to an RGB color space having color components comprising a red-component, a green-component, and a blue-component.

3. The method of claim 2, wherein if the value of the opacity component is not equal to zero or about zero, inserting a value of 1 in each of the RGB color space components and a value of 0 in the opacity component.

4. The method of claim 1, wherein converting the luminance component of a first pixel in a first image of the first video stream to an opacity component comprises performing the following calculation:
A=Y/C
where A is a value of the opacity component and Y is a received Y component of a pixel from the first video stream, and C is a constant integer.

5. The method of claim 4, wherein the value of C is 255.

6. The method of claim 4, further including calculating RGB color space components using the following equations:
R=Y+1.13983*V
G=Y−0.39465*U−0.58060*V
B=Y+2.03211*U
where Y, U, and V are the luminance and chrominance values respectively of a pixel in the second video stream, and R, G, B, are a red component, a green component, and a blue component values respectively of a pixel in the output video stream.

7. A method of creating two video streams lacking support for an alpha channel from a video stream supporting an alpha channel component, the method comprising:
receiving into non-transitory memory a video stream having color components and an opacity component in a first color space;
converting, using a computing processor, the color components from the first color space into color components of a second color space;
converting, using the computing processor, the opacity component into a color component of the second color space;
outputting a first video stream having the converted opacity component; and
outputting a second video stream having the converted color components.

8. The method of claim 7, wherein the first color space is RGBA and the second color space is YUV.

9. The method of claim 7, wherein converting the opacity component
includes calculating
Y=A*C;
where A is a value of the opacity component, Y is a luminance component of the first outputted video stream, and C is a constant integer.

10. The method of claim 9, wherein C equals 255.

11. The method of claim 9, wherein converting the color components from the first color space to color components of a second color space comprises performing the following calculation:
Y=0.299*R+0.587*G+0.114*B
U=−0.14713*R−0.28886*G+0.436*B
V=0.615*R−0.51499*G−0.10001*B
where Y is a Y component for the second video stream, U is a U component of the second video stream, and V is a V component of the second video stream, and R, G, B, are a red component, a green component, and a blue component values respectively of an output pixel.

12. A system for creating a video stream, the system comprising:
a receiver receiving and storing first and second video streams into non-transitory memory, each video stream having a luminance component and two chrominance components, the first video stream being different than the second video stream;
a first converter executing on a computing processor and converting the luminance component of the second video stream into an opacity component;
a second converter executing on the computing processor and converting the chrominance and luminance of the first video stream into an output video stream having an RGB color space when a value of the opacity component is about zero; and
a combiner executing on the computing processor and combining the output video stream and the opacity component and outputting the combined video stream.

13. The system of claim 12, wherein the first converter converts the luminance component of the second video stream into an opacity component using the following equation:
A=Y/C
where A is a value of the opacity component and Y is a received Y component from the first video stream, and C is a constant integer.

14. The system of claim 13, wherein C equals 255.

15. The system of claim 12, wherein the second converter converts the chrominance and luminance of the first video stream into an output video stream having an RGB color space using the following equations:
R=Y+1.13983*V
G=Y−0.39465*U−0.58060*V
B=Y+2.03211*U
where Y, U, and V are luminance and chrominance values respectively of a pixel in the second video stream, and R, G, B, are a red component, a green component, and a blue component values respectively of an output pixel.

16. A system for creating first and second video streams, the system comprising:
a receiver receiving and storing an input video stream into non-transitory memory, the video stream being in an RGBA color space comprising a red component, a green component, a blue component, and an alpha component;
a splitter executing on a computing processer, the splitter:
converts the alpha component into a first output video stream; and
converts the red component, the green component, and the blue component into a second output video stream in a YUV color space;
outputs the first and second output video streams.

17. The system of claim 16, wherein converting the alpha component includes calculating:
Y=A*C;
where A is an alpha channel value, Y is a luminance component of the second outputted video stream, and C is a constant integer.

18. The system of claim 16, wherein C equals 255.

19. The system of claim 16, wherein converting the red component, the green component, and the blue component into a second output video stream in a YUV color space comprises performing the following calculation:
Y=0.299*R+0.587*G+0.114*B
U=−0.14713*R−0.28886*G+0.436*B
V=0.615*R−0.51499*G−0.10001*B
where Y is the Y component for the second video stream, U is the U component of the second video stream, and V is the V component of the second video stream, and R, G, B, are a red component, a green component, and a blue component values respectively of an output pixel.
